(19) United States
(12) Patent Application Publication
(10) Pub. No.: US 2024/0330875 A1
(43) Pub. Date: Oct. 3, 2024

(54) PayBlox: Payment Processor/Payment Solution and Merchants Matching Platform

(71) Applicant: 33 Operations, Inc., North Eastham, MA (US)

(72) Inventor: Brett Husak, Eastham, MA (US)

(21) Appl. No.: 18/621,975

(22) Filed: Mar. 29, 2024

Related U.S. Application Data
(60) Provisional application No. 63/455,503, filed on Mar. 29, 2023.

(51) Int. Cl. G06Q 20/02

(52) U.S. Cl. CPC G06Q 20/02

(57) ABSTRACT

A marketplace tool and platform to connect payment processor/payment solutions, payment solutions and merchants via a matching system which utilizes a combination of algorithms and machine learning tools to align the merchants looking for new payment processor/payment solutions and the payment processor/payment solutions looking for merchants.

### CROSS-REFERENCE TO RELATED APPLICATIONS

This application claims the benefit of the filing date of U.S. Provisional Patent Application Ser. No. 63/455,503, which was filed on Mar. 29, 2023, and is fully incorporated herein by reference.

### FIELD OF THE INVENTION

The present invention relates generally to solutions for payment transaction system participants. More specifically, embodiments of the present invention relate to the payment processor/payment solutions, payment solutions and merchants, and a matching platform to connect those entities within their field of interest.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

To enable convenient purchases of goods and services from merchants by consumers, the financial services industry has developed many alternative payment methods to cash, including checks, ATM or debit cards, credit cards, charge cards, and include, but are not limited to, alternative forms of payment, such as closed loop, crypto, etc. As discussed below, these payment options are intended to provide convenience and adequate transactional security to both consumers and merchants participating in the marketplace.

Transactional security can be defined, among other ways, as the security offered by a payment method to the buyer and to the seller during a purchase transaction involving both parties such that the purchase event will not result in a breach of personal information or financial loss from fraud perpetrated upon either party involved, often by another uninvolved party intruding into the process.

The continued growth of commerce into increasingly digital spaces has put pressure on the payment options cited above on both the convenience and transactional security dimensions, although those dimensions are frequently not aligned. Specifically, checks require physical presentment and clearing of the check prior to shipment of goods. Credit cards are more convenient for the consumer but are subject to fraudulent use via theft of the account number, expiration date, and address of the consumer. Debit cards lack a credit facility and often require a separate personal identification number (PIN) to be used. Today, all the improvements offered have sought to improve transactional security at the expense of the convenience during the purchase process.

The third party in this transaction is the payment processor/payment solution and or payment solution, which is defined as the company in the financial service industry which facilitates the transaction request from the merchant selling the good or service and arranges the draw of funds from the payment source authorized by the consumer in the relationship for the case of an individual transaction.

Currently when a merchant and a processor execute an agreement so that the processor will handle the merchant's electronic payment transactions, the processor creates a merchant account for the merchant that identifies the merchant and defines the parameters related to that agreement. Such an agreement defines the types of transactions that the merchant is authorized to undertake and includes merchant ID, processor ID, and a merchant account ID. This data is stored in a secure environment, optimally one identified as Payment Card Industry (“PCI”) compliant, as controlled by the PCI Security Standards Council. Once the arranged payment interface pathway is configured so that communication with the processor occurs within the required parameters, including a merchant profile and identification of the specific point of sale (“POS” or “Terminal”) unit or electronic platform, this allows for identification of the parameters related to the merchant agreement with the processor and of the specific POS terminal unit involved in the transaction. The payment interface unit will create a transaction request based on the customer profile (or “customer ID”), the processor application, the merchant profile (or “merchant ID”), the specific POS Terminal ID, and the total payment amount due. Accordingly, external vendors are potentially utilized to install and configure the payment interface units at the merchant POS Terminal sites, so that they address the processor's application requirements and enable communications channels between the specific merchant and specific processor.

In this field, a number of technologies have been created to augment or facilitate this three-party relationship. Among implementations for discussion in this background are the following:
a. US20140249999A1 discloses a computer-implemented multiple merchant payment processor/payment solution (hereafter may be referred to as ‘Processor’) method. The method comprises receiving, using one or more data processors, a payment request associated with a site, identifying, using the one or more data processors, a site profile associated with the site, wherein the site profile is associated with one or more account processors and one or more transaction preference rules for selecting one of the account processors; processing, using the one or more data processors, information associated with the payment request according to one or more transaction preference rules to select one of the account processors; and sending, using the one or more data processors, a payment processing request to the selected account processor.
b. US20140351006A1 discloses a system and method for utilizing global information determined from commercial transactions by first storing data identifying a plurality of store locations of the multi-point merchant. The stored data is associated with an account of the multi-point merchant. A transaction record is received from each of a plurality of devices. Each of the devices is associated with a corresponding store location of the multi-point merchant. The information provided with each transaction record is processed in order to extract information that is non-specific to at least each of a corresponding transaction, a user of the corresponding transaction, and a merchant of the transaction. The processed information is then aggregated based on one or more global criteria so that reports may be generated based on the processed information and the one or more global criteria.
c. US2012072347A1 discloses a method, processing device and computer readable media, for routing a credit card payment transaction over a communication network. The method comprises receiving an authorization request for the credit card payment transaction at a payment processor/payment solution, the authorization request being generated at a merchant terminal of a merchant. The method also comprises: at the payment processor/payment solution, determining an optimal transaction route for sending the authorization request over the communication network to one of multiple acquirer servers, each one of the multiple acquirer servers being associated to one of multiple acquiring financial institutions of the merchant, the determining being based on payment processing costs associated to routing the authorization request from the merchant terminal to each one of the multiple acquirer servers; the payment processor/payment solution routing the authorization request to the one of the multiple acquirer servers implementing the optimal transaction route; the payment processor/payment solution receiving, from the one of the multiple acquirer servers, an authorization response for the authorization request; the payment processor/payment solution forwarding the authorization response to the merchant terminal; and the merchant terminal displaying the authorization response forwarded by the payment processor/payment solution, to thereby notify a user of the authorization response.
d. WO2020075155 discloses a system of bidding and routing of payments for cards transactions, and more particularly, to the bidding of merchants expected future or current transaction volume and routing of payment transactions based at least in part upon one or more merchant parameters. The bidding system enables merchants to choose payment cards processors and/or payment networks or other financial institutions based on results of a bidding process for merchant future expected revenue transactions and sales.

All the above patents and applications of technology cover specific aspects of the potential relationship between merchant, processor, and consumer; however, none of them address the nature of this specific innovation-a marketplace for the facilitation the relationship between processor and merchant.

In the common relationship between a processor and merchant, payment processor/payment solutions or payment solutions charge some amount of fee to the merchants which may vary for different payment processor/payment solutions, types of goods, and volumes of service. When any merchant enters into an agreement with a payment processor/payment solution/payment solution, one of the major criteria for selecting a payment processor/payment solution/payment solution is the amount of fees which is being charged by a payment processor/payment solution/payment solution.

While those fees are normally distilled down to a percentage of total amount, they frequently also include minimum or maximum monthly transaction by volume or number, and potentially the leasing or purchase of hardware to facilitate the communication at a point-of-sale terminal. If physical hardware enters the relationship between merchant and processor, the age, maintenance, and disposition of that hardware could likely become a factor in their decision to maintain or leave a relationship with a specific processor.

Besides physical device age or condition, software compatibility issues can also prevent the merchant from realizing the full potential of the any payment gateways provided by the processor. This is a particular concern if the merchant is working with the same provider for a long period of time, as all platforms must continually respond in the PCI industry auditing process to meet evolving requirements for compliance.

For physical devices presence, a POS system represents a significant investment, and many systems are only compatible with certain processors. Likewise, for a software payment terminal build, crafting and maintaining the software for a website payment portal with a specific processor is costly. If a merchant is considering switching a relationship between payment processor/payment solutions/payment solution on any front, the said merchant will likely have to perform careful research to ensure that their systems will be compatible with a new provider before making the switch. Any cost savings the merchant hopes to realize with a new provider could disappear completely if the merchant has to replace physical hardware, or retool a website system.

One fact which influences processor fee structures, and thus merchant costs, is the slim margins of potential profit for processors, as some costs are out of their direct control. Interchange fees for any transaction are set by either the major credit card associations, or the primary bank payment rails, and constitute most processing costs.

From a merchant's perspective, a commonly acceptable contract arrangement for a merchant account is month-to-month billing with no early termination fee. The merchant under this plan would be free to leave whenever they wish, and with no penalty. However, in the present time, the industry standard is typically a long-term contract with a one to three-year initial period. This contract will also frequently include an automatic renewal clause that will extend contracts for one-year periods after the initial term has expired. In effect, the contract continues indefinitely, with only a narrow window of time at the end of the current contract period where the merchant can close his account without incurring a penalty.

From a payment processor/payment solution's perspective, the ideal goal is to build long-term relationships with merchants that fit their risk profile, and for the processors payment systems to be leveraged actively.

From these two opposite points of connection, we can conclude that classical payment processor/payment solutions, and their expected propensities, have strongly influenced the market direction.

The disclosure presented herein addresses the bridge between the two positions of merchant and processor, and facilitates a communication pathway to encourage that both parties may explore and select a solution to provide services to support their transactions.

### SUMMARY OF THE INVENTION

This summary is provided to introduce a selection of concepts in a simplified format that are further described in the detailed description of the present disclosure. This summary is not intended to identify key or essential inventive concepts of the present disclosure, nor is it intended for determining the scope of the present disclosure.

A principal objective of the present invention is to provide an improved novel platform for payment processor/payment solutions and merchants for benefiting the merchant as well as the payment processor/payment solution, and by transference, the customers of said merchant. Merchants are traditionally, and often intentionally, misled by marketing sites regarding who is the “best” solution via the placement order on google of the paid review sites and other paid advertising options. This payment process/payment solution seeks to level the playing field for the merchant with transparent and timely routing and offerings.

It is another objective of the disclosure to improve the merchant experience when searching for a processor by producing multiple options in the form of processor offers without the need for multiple applications and allowing them to filter potential payment processor/payment solutions based on processing rates, or other key factors which are of primary concern to their business needs. These functions of the platform should increase choices for merchants, and thus increase fair competition within this market, more broadly speaking.

In the same manner, this disclosure provides an improved method for payment processor/payment solutions to filter, search, and respond to leads of potential merchants via collected data set out in the platform descriptions. This improvement should reduce payment processor/payment solution costs related to acquiring merchant accounts and provide a new novel experience.

An additional aspect of the present disclosure is a platform that improves efficiency, increases choices, and lowers costs for payment processor/payment solutions and merchants by utilizing a matching process wherein said platform uses a machine learning algorithm to match the merchants looking for new payment processor/payment solutions and the payment processor/payment solutions looking for more merchants to grow their client base. The disclosed platform allows the merchants to choose among the payment processor/payment solution based on the payment processor/payment solution offers, as specifically related to their own business requirements.

The platform includes a parsing function that will receive, sanitize, and reorganize merchant data to provide detailed business profiles for the payment processor/payment solutions without disclosing identifying information of said merchants, but still provides ample information within a simple user interface which provides an efficient means for payment processor/payment solutions to build decision making automations for making offers to merchants. When a match is made by the platform, payment processor/payment solutions may submit offers. Only when an offer is accepted by a merchant will identifying information be shared with the payment processor/payment solution whose offer has already been accepted.

To further clarify the advantages and features of the present disclosure, a more particular description of the disclosure will be rendered by reference to specific embodiments thereof, which is illustrated in the appended drawings. These drawings depict only typical embodiments of the disclosure and are therefore not to be considered limiting in scope. The disclosure will be described and explained with additional specificity and detail with the accompanying drawings.

### BRIEF DESCRIPTION OF DRAWINGS

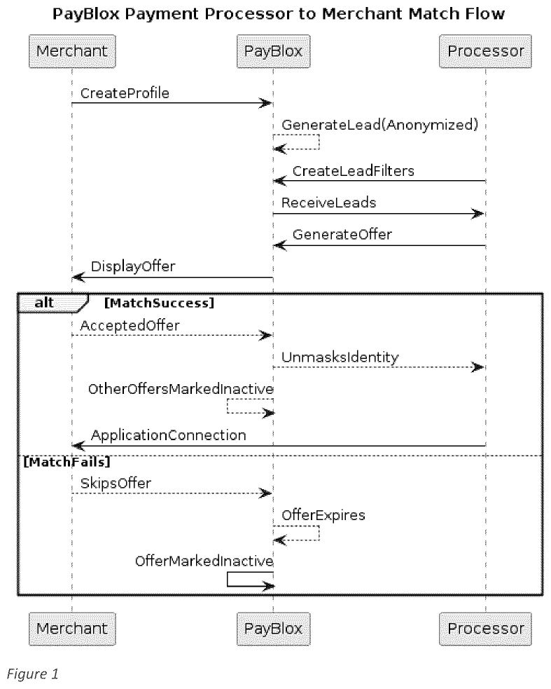

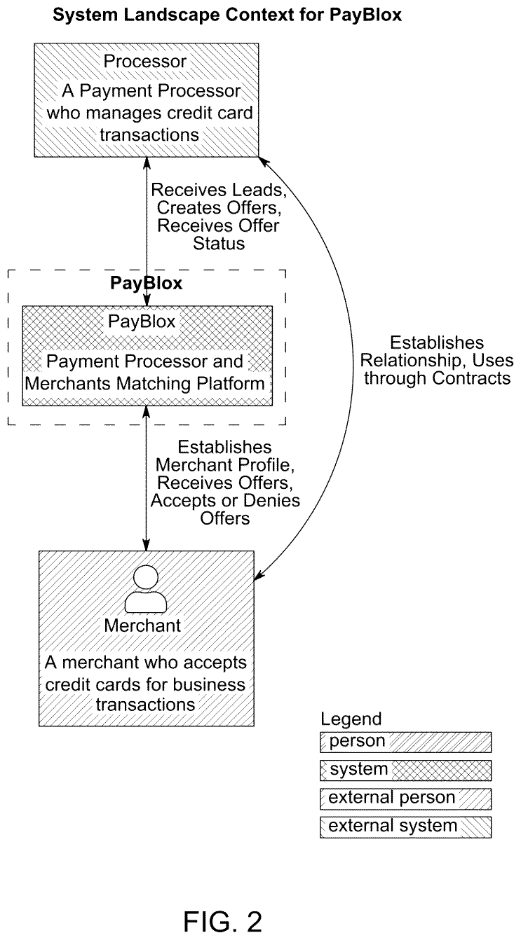

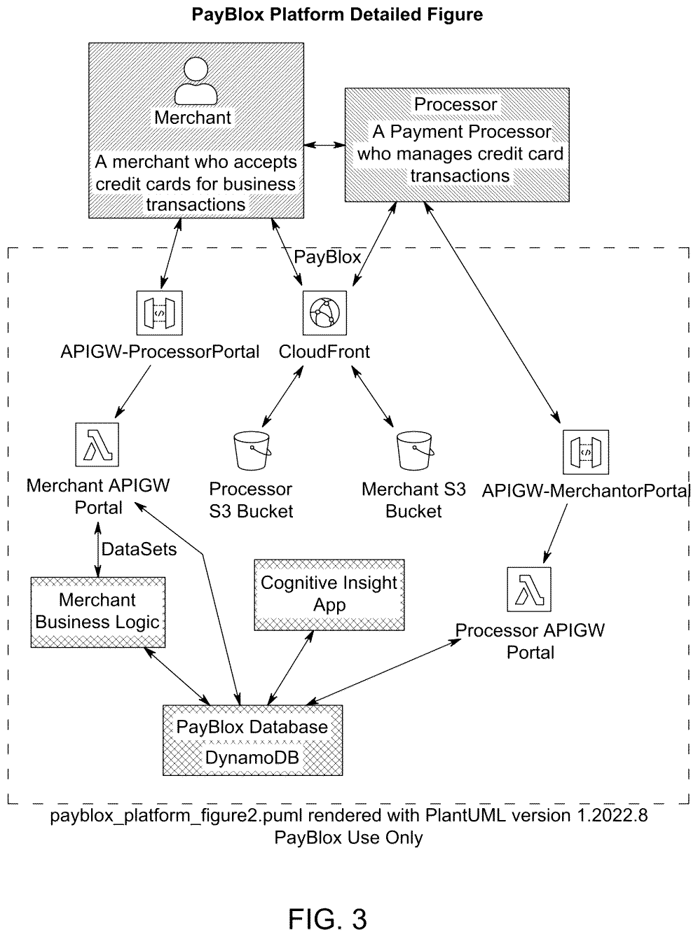

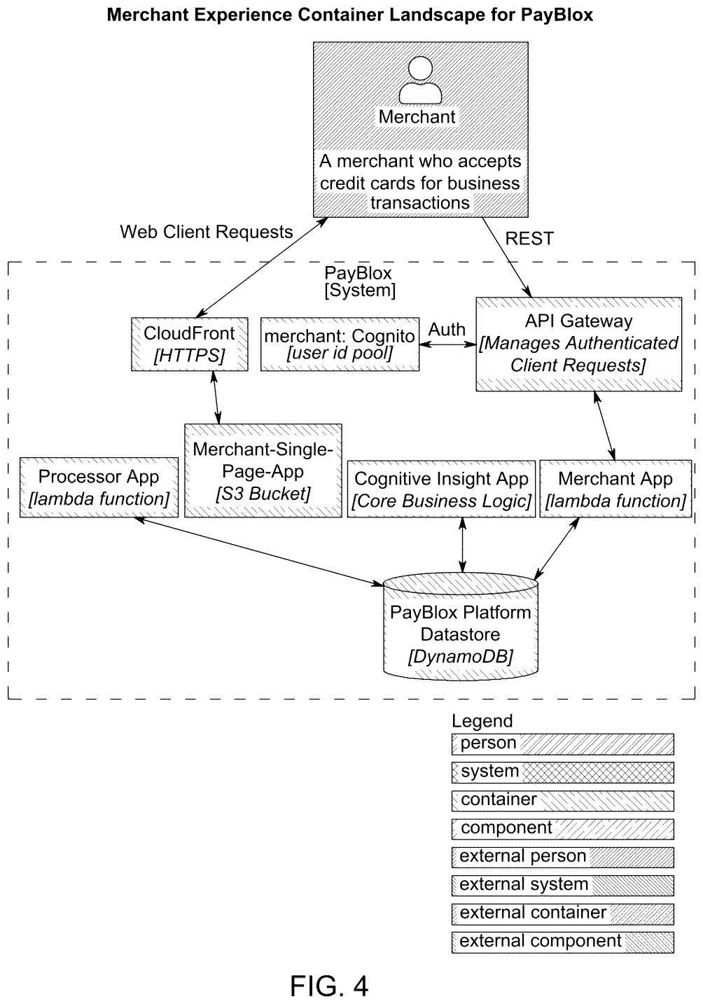

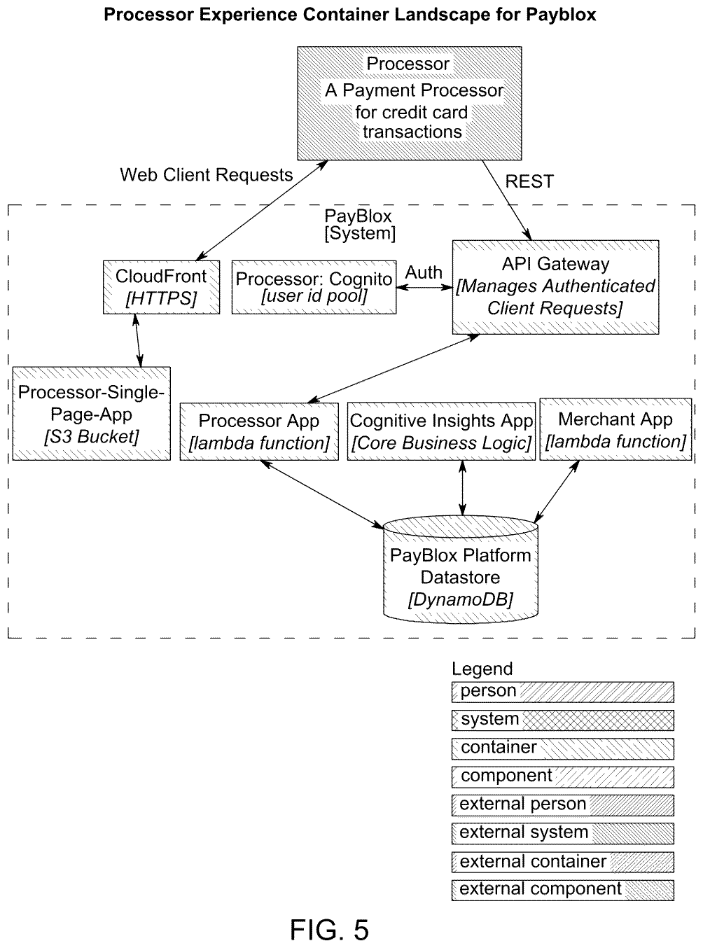

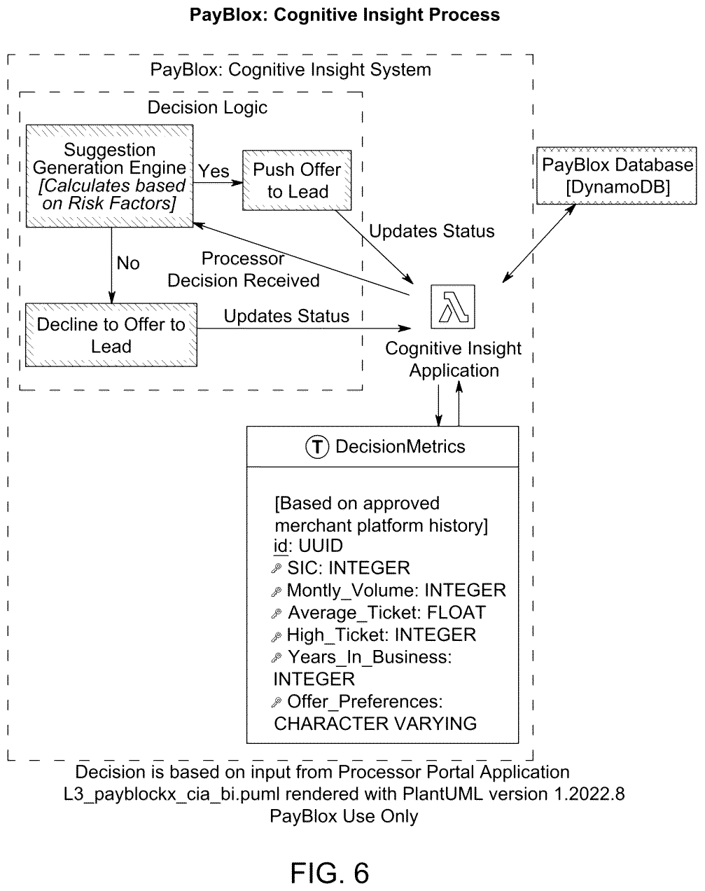

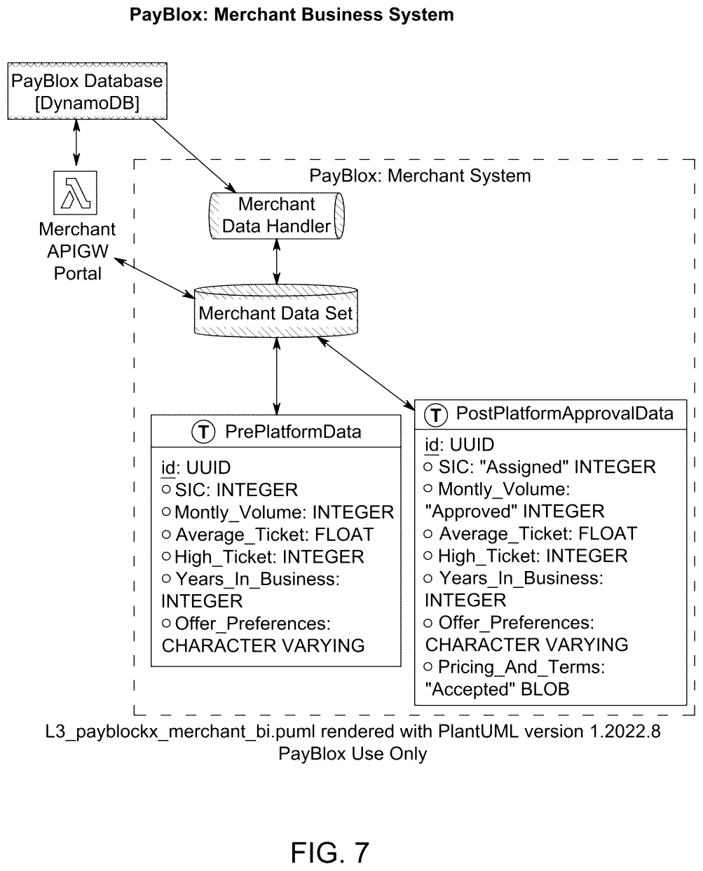

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:
a. FIG. 1 illustrates a flow chart of the relationship of the disclosed platform with the Merchant and the Processor, in accordance with an embodiment of the present disclosure;
b. FIG. 2 illustrates the overall context of interactions between this invention, Merchants and Processors;
c. FIG. 3 illustrates a system flow diagram of all inbound and outbound interactions with the PayBlox Platform;
d. FIG. 4 and FIG. 5 illustrate block diagrams showing the working of the disclosed platform, in accordance with an embodiment of the present disclosure for both merchant and processor logic flows;
e. FIG. 6 illustrates the core working of the business logic component: cognitive insight application, which includes the offer optimization logic and necessary supporting algorithms to handle decisions;
f. FIG. 7 illustrates the merchant data stores necessary to feed the cognitive insight application;

Further, the elements in the drawings are illustrated for simplicity and may not have necessarily been drawn to scale. In terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated. Unless otherwise defined, all technical and scientific terms used herein have the same meaning as commonly understood. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

Reference is made herein to some “embodiments.” An embodiment is an example of a possible implementation of any features and/or elements presented in the included disclosure. Some embodiments have been described for the purpose of illuminating one or more of the potential ways in which the specific features and/or elements of the included disclosure fulfill the requirements of uniqueness, utility, and non-obviousness.

The present disclosure provides a matching platform between payment processor/payment solutions and merchants. This platform uses a combination of targeted algorithms and machine learning tools to match merchants with payment solutions, processors, etc. The disclosed system allows the merchants to choose among the payment processor/payment solutions based on the offers presented to them by the processors. The platform also allows processors and payment solutions to fine-tune their offers to merchants per their business requirements. The matching algorithms will consume feedback and data from successful and unsuccessful matching to continuously adapt and improve matching efficiency success.

According to an embodiment of the present disclosure, merchant identifying information will be kept private until a merchant has received and accepted an offer from a payment processor/payment solution. Payment processor/payment solutions viewing merchant profiles will have access to merchant information related to business performance, business classification, and other data which gives a complete business profile while keeping the identity of the business anonymous and private.

The revenue model of the disclosed platform will be based on successful matches that lead to accepted offers. Processors will not pay to view merchant profiles or make offers. Processors will be enabled to act on leads with an offer. When an offer from a processor to a merchant is accepted by the merchant, the processor will be charged for the successful connection and offer acceptance. Only then will the identity of the prospective merchant be revealed to the processor.

According to an embodiment, the present disclosure provides a platform which combines a matching function, offer/acceptance process, and user communication which will provide more options for both parties, increase competition, lower costs, and improve efficiencies within the target market.

The disclosed platform offers an equally distributed revenue-sharing program for all merchants who have an active contract with a payment processor/payment solution they established through the disclosed invention. Said program does require a minimum monthly volume participation threshold set forth in the terms and conditions.

Sanitized merchant data will be usable to create flexible promotions for merchants in preparation for contracts with processors on the platform.

According to an embodiment of the present disclosure, in an embodiment, the platform comprises a plurality of information fields regarding the merchants which may include the first and last name (or entity name) of the merchant, place of business, email, industry classification, transaction volume per month, etc. Further, the disclosed platform comprises a directory of codes for each listed service provider.

According to an embodiment of the present disclosure, FIG. 1 illustrates a flow chart of the relationship of the disclosed platform with the merchant and the payment processor/payment solution. This figure shows the user using the disclosed platform of the present invention where the platform creates a merchant account, displays the offers provided by the payment processor/payment solutions, and provides options to the merchants for selecting offers.

According to an embodiment of the present disclosure, FIG. 2 illustrates a process flow diagram of merchant profile creation to offer selection done by the disclosed platform. The disclosed platform creates a merchant profile account, then the merchant requests the available offers provided by the payment processor/payment solutions, creates metaleads, then matches the processor filter, and sends metaleads to the processor user interface and other methods. Further, FIG. 2 shows creation of the processor's offer, sending offers to the merchants, acceptance of an offer by the merchant, while removing declined offers. Further, sending merchant identifying information upon offer acceptance to the processor.

In the merchant profile creation process, a user or merchant signs up for the platform and goes through an onboarding process where they supply information about the business similar to information they would normally have to submit to every payment processor/payment solution or payment solution they want to receive offers from. Instead, the merchant profile is created once, identifying information is masked, and the profile is matched and displayed to payment processor/payment solutions whose merchant acceptance parameters match those of said merchant profiles.

According to an embodiment of the present disclosure, FIGS. 3 and 4 illustrate block diagrams displaying the process flow of the disclosed platform. FIG. 3 shows a merchant portal, a processor portal, and their positions in the disclosed platform. The merchant portal, the payment processor/payment solution portal, and the disclosed platform comprise various data which are collectively analyzed for the offer preference matching and selection of the payment processor/payment solutions.

The figures and the forgoing description give examples of embodiments. What is described may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all the acts necessarily need to be performed. Also, those acts that are not dependent on other acts may be performed in parallel with the other acts. The scope of the embodiments is not limited by these specific examples. Numerous variations, whether explicitly given in the specification or not, such as differences in structure, dimension or use, are possible.

What is claimed is:

1. A computer implemented method of matching at least one merchant profile with one or more of a plurality of payment processor profiles, comprising:
electronically receiving at least one merchant profiles, each merchant profile comprising features and requirements of a respective merchant and associated with a set of one or more available hardware elements;
electronically receiving a plurality of payment processor profiles, each payment processor profile comprising features and requirements of a respective payment processor and associated with a set of one or more required hardware elements;
electronically receiving a first request, the first request electronically submitted by a merchant using a first electronic device, said electronic device comprising a graphical user interface, said first request including a selection, from an array displayed on said graphical user interface, of at least one of the one or more available hardware elements;
determining a first set of potential matches from the plurality of payment processor profiles for the merchant in response to receiving the first request;
determining, for each potential match in the first set of potential matches, whether the one or more available hardware elements is in the set of one or more required hardware elements;
creating a second set of potential matches by removing payment processor profiles wherein the one or more available hardware elements is not in the set of one or more required hardware elements from the first set of potential matches;
sending a redacted merchant profile to each payment processor profile in the second set of potential matches wherein, when at least one offer is received from one or more of the payment processor profiles of the second set of matches in response to sending the redacted merchant profile, all of at least one offers are sent to the merchant profile;
sending all of the at least one offers to the merchant profile;
determining whether the merchant accepts one of the at least one offers, in part by determining whether the merchant selects, for each of the at least one offers, one of:
an interaction with the graphical user interface denoting acceptance,
an interaction with the graphical user interface denoting rejection, or
an interaction with the graphical user interface denoting conditional rejection,
wherein the interaction with the graphical user interface denoting acceptance results in a match between the merchant profile and the payment processor profile;
wherein the interaction with the graphical user interface denoting rejection results in deletion of the payment processor profile; and
wherein the interaction with the graphical user interface denoting conditional rejection results in at least one offer being returned to the payment processor profile with a request to modify the terms of the offer.

2. The computer implanted method of matching at least one merchant profile of claim 1 wherein the merchant profile information incorporated within the features and requirements can be adjusted to increase the pool of potential matches prior to sending offers to the merchant profile.

3. The computer implanted method of matching at least one merchant profile of claim 1 wherein the payment processor and payment solutions may view all merchants matching the selection parameters.

4. The computer implemented method of matching at least one merchant profile of claim 1 wherein the payment processor/payment solutions and payment solutions only pay when a merchant accepts their offer.

5. The computer implemented method of matching at least one merchant profile of claim 1 wherein the users and merchants compare and select from offers presented through the user interface through randomized ordering and display of potential matches.

6. The computer implemented method of matching at least one merchant profile of claim 1 wherein the graphical user interface incorporates directional specific categorization features for categorizing displayed matches dependent upon which direction the user shunts the display.

7. The computer implemented method of matching at least one merchant profile of claim 1 wherein automatic notifications are displayed on user hardware elements to alert users of information.
